(19) United States
(12) Patent Application Publication
(10) Pub. No.: US 2010/0097737 A1
(43) Pub. Date: Apr. 22, 2010

(54) LOAD DRIVING DEVICE

(75) Inventors: Manabu HIRATA, Aichi (JP); Satoki Uruno, Aichi (JP); Hiroki Kishi, Aichi (JP); Junichi Matsubara, Aichi (JP); Yuichiro Mori, Aichi (JP); Michiyoshi Shimizu, Aichi (JP)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: KABUSHIKI KAISHA TOKAI RIKA DENKI SEISAKUSHO, Aichi (JP)

(21) Appl. No.: 12/581,589

(22) Filed: Oct. 19, 2009

(30) Foreign Application Priority Data
Oct. 21, 2008 (JP) 2008-270903

(51) Int. Cl. H02H 3/08

(52) U.S. Cl. 361/101

(57) ABSTRACT

A load driving device including a semiconductor switch arranged in a current path extending from a power supply to a load. A control circuit controls activation and deactivation of the semiconductor switch. The control circuit deactivates the semiconductor switch when it is determined that overcurrent is flowing through the current path. A current detector detects current that is flowing through the current path. The control circuit determines that overcurrent is flowing when the current detector continuously detects current that is greater than a threshold value over a predetermined detection time. The detection time is set to be shorter than the time from when the current in the current path exceeds the threshold value to when an increase in resistance value of the semiconductor switch resulting from heat generated by the current lowers the current to the threshold value.

### CROSS-REFERENCE TO RELATED APPLICATIONS

This application is based upon and claims the benefit of priority from prior Japanese Patent Application No. 2008-270903, filed on Oct. 21, 2008, the entire contents of which are incorporated herein by reference.

### BACKGROUND OF THE INVENTION

The present invention relates to a load driving device having an overcurrent protection function for protecting a circuit element from overcurrent in a semiconductor switch or the like that switches current flowing from a power supply to a load.

A conventional load driving device is used to drive and control a load, such as a motor or a lamp, by activating and deactivating a switching element that is arranged in a current path between a DC power supply and a load. Load driving devices are used in various technical fields including the automotive field.

In such a load driving device, a load may be short-circuited due to factors such as dust and moisture. In such a case, the internal resistance value of the load becomes extremely small. As a result, excess current, or overcurrent, having a value that is greater than the value of steady current flows to the switching element. The overcurrent or heat generated by the overcurrent may damage the switching element.

Japanese Laid-Open Patent Publication No. 2008-67489 describes a load driving device having an overcurrent protection function that detects overcurrent and deactivates a switching element to protect the switching element from overcurrent or heat and prevent damages. The load driving device includes a control circuit to control a current detection circuit, which is arranged in a current path connecting a DC power supply to a load, that continuously detects the current supplied to the load. When current that is greater than or equal to a predetermined threshold value is detected for a predetermined detection time, the control circuit determines that an overcurrent condition exists and deactivates the switching element. This prevents the switching element from being damaged by the overcurrent.

The switching element has a resistance value (on resistance) that increases as the temperature rises when heated. Accordingly, the current value detected when overcurrent is flowing decreases as time elapses. Thus, the value of the overcurrent may become less than the threshold value before the predetermined detection time elapses. This may result in the overcurrent being erroneously determined as a steady current.

### SUMMARY OF THE INVENTION

In one embodiment, the present invention provides a load driving device that correctly detects overcurrent and activates an overcurrent protection function in such a case.

A load driving device including a semiconductor switch arranged in a current path extending from a power supply to a load. A control circuit controls activation and deactivation of the semiconductor switch. The control circuit deactivates the semiconductor switch when it is determined that overcurrent is flowing through the current path. A current detector detects current flowing through the current path. The control circuit determines that overcurrent is flowing through the current path when the current detector continuously detects current that exceeds a threshold value over a predetermined detection time. The detection time is set to be shorter than the time from when the current flowing through the current path exceeds the threshold value to when an increase in resistance value of the semiconductor switch resulting from heat generated by the current lowers the current to the threshold value.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a circuit diagram of a load driving device in a preferred embodiment;

FIG. 2 is a graph showing a threshold value and an overcurrent determination time for the load driving device of FIG. 1; and

FIG. 3 is a graph showing changes in an inrush current over time for the load driving device of FIG. 1.

### DETAILED DESCRIPTION OF THE PREFERRED EMBODIMENTS

In the drawings, like numerals are used for like elements throughout.

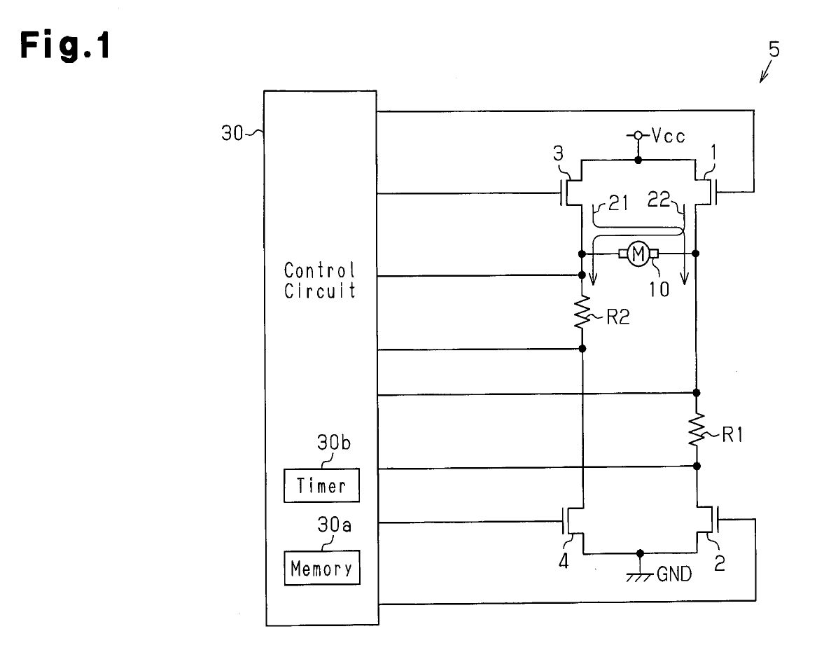

A preferred embodiment of a load driving device according to the present invention will now be discussed with reference to FIGS. 1 to 3. In one example, the load is a motor 10 that is installed in a vehicle, and the load driving device 5 is a device for driving the motor 10. As shown in FIG. 1, the load driving device 5 includes an H-bridge circuit formed by a first series circuit and a second series circuit, which are connected between a DC power supply Vcc and ground GND. The first series circuit includes a first field-effect transistor (FET) 1 and a second FET 2. The second series circuit includes a third FET 3 and a fourth FET 4. A motor 10 is connected to a node between the first FET 1 and second FET 2 and a node between third FET 3 and fourth FET 4. The gate terminals of the first to fourth terminals FET 1 to FET 4 are each connected to a control circuit 30.

Further, a current detection resistor R1 is arranged between the second FET 2 and the motor 10. The two terminals of the resistor R1 are connected to the control circuit 30. In the same manner, a current detection resistor R2 is arranged between the fourth FET 4 and the motor 10. The two terminals of the resistor R2 are also connected to the control circuit 30. Each of the resistors R2 is an example of a current detector. Based on a command from an external device (not shown), the control circuit 30 controls the switching of the FETs 1 to 4 so that the motor 10 produces forward rotation or reverse rotation. Further, the control circuit 30 detects the voltage between the two terminals (hereinafter, simply referred to as voltage) of each of the resistors R1 and R2 and calculates the value of the current flowing to the H-bridge circuit from the detected voltage values. The load driving device 5 may be integrated into a single IC chip or be formed from elements mounted on a substrate.

The control circuit 30 includes a non-volatile memory 30a. The memory 30a stores a threshold value (reference current value i0) for determining whether or not the detected current value is of an overcurrent level. The control circuit 30 also includes a timer 30b. The timer 30b starts operating when the detected current value exceeds the threshold value. When the period during which the detected current value exceeds the threshold value becomes longer than a predetermined overcurrent determination time (detection time) T1, the timer 30b is incremented. The control circuit 30 compares the detected current value with the threshold value. When current exceeding the threshold value is continuously detected during the overcurrent determination time T1, the control circuit 30 determines that overcurrent is flowing. When it is determined that overcurrent is flowing, the control circuit 30 performs an overcurrent protection operation.

The overcurrent determination time T1 is set taking into consideration the amount overcurrent varies due to changes in the on resistance resulting from the heating of an FET. In the preferred embodiment, the overcurrent determination time T1 is set to be shorter than the time in which overcurrent decreases to the reference current value i0 as the on resistance (resistance value) of the FET increases. More preferably, the overcurrent determination time T1 is set taking into consideration the inrush current that is momentarily generated when the motor 10 starts to operate. In this case, the overcurrent determination time T1 is set to be longer than the time from when the inrush current exceeding the threshold value is generated to when the inrush current decreases to a value that is less than the threshold value. The threshold value (reference current value i0) is set to be large enough so that a current value in a steady current range 15 is not detected and small enough so that overcurrent may be detected over the overcurrent determination time T1. Further, the reference current value i0 must be set in compliance with an FET standard or the like at a level allowing for stable operation of the FET when flowing thereto. The flow of overcurrent is detectable by the control circuit 30 even when an FET is heated by optimizing the level of the reference current value i0.

The operation of the load driving device 5 will now be discussed. When producing forward rotation with the motor 10, the control circuit 30 activates the second FET 2 and the third FET 3 by applying voltage to the gate terminals of the second and third FETs 2 and 3, while deactivating the first FET 1 and the fourth FET 4. As a result, current flows in a forward direction 21 from the third FET 3 via the motor 10 to the second FET 2. This produces forward rotation with the motor 10.

When producing rearward rotation with the motor 10, the control circuit 30 activates the first FET 1 and the fourth FET 4, while deactivating the second FET 2 and the third FET 3. As a result, current flows in a reverse direction from the first FET 1 via the motor 10 to the fourth FET 4. This produces rearward rotation with the motor 10.

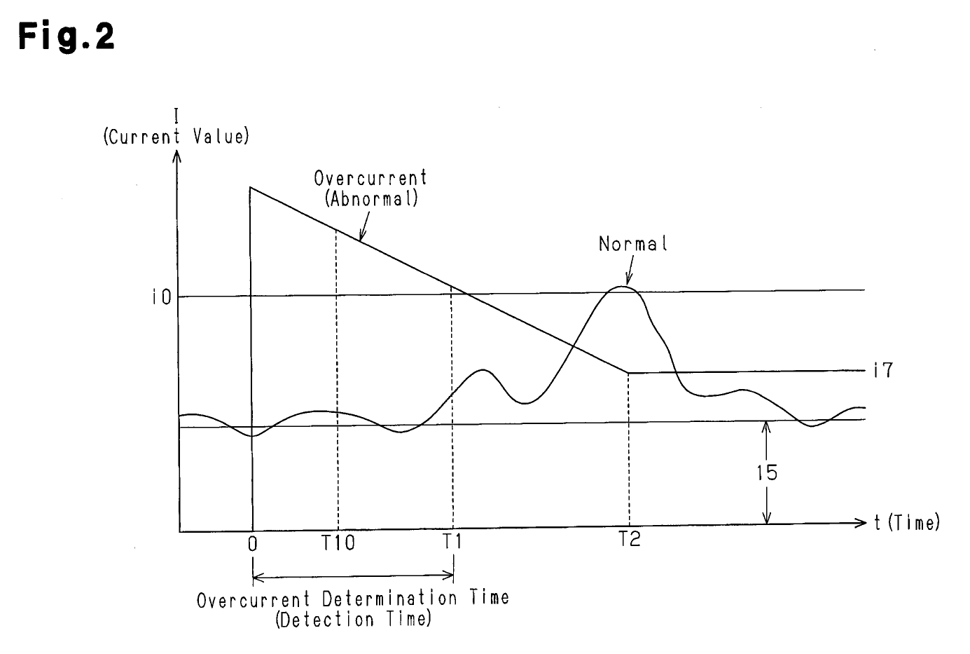

When the motor 10 is being driven, the control circuit 30 constantly detects whether or not overcurrent exists. More specifically, the control circuit 30 compares the detected current value with the threshold value (reference current value i0) prestored in the memory 30a. Referring to FIG. 2, in a normal state, the current value remains less than the threshold value (reference current value i0). A voltage fluctuation in the DC power supply may cause the current value to exceed the threshold value. However, the current value would not remain greater than or equal to the threshold value (reference current value i0) over the overcurrent determination time T1. In this manner, during a normal state, the detected current value does not continuously exceed the reference current value i0 over the overcurrent determination time T1. Thus, the control circuit 30 determines that overcurrent is not flowing. In this case, the control circuit 30 continues to control the switching of the FETs 1 to 4, that is, the driving of the motor 10.

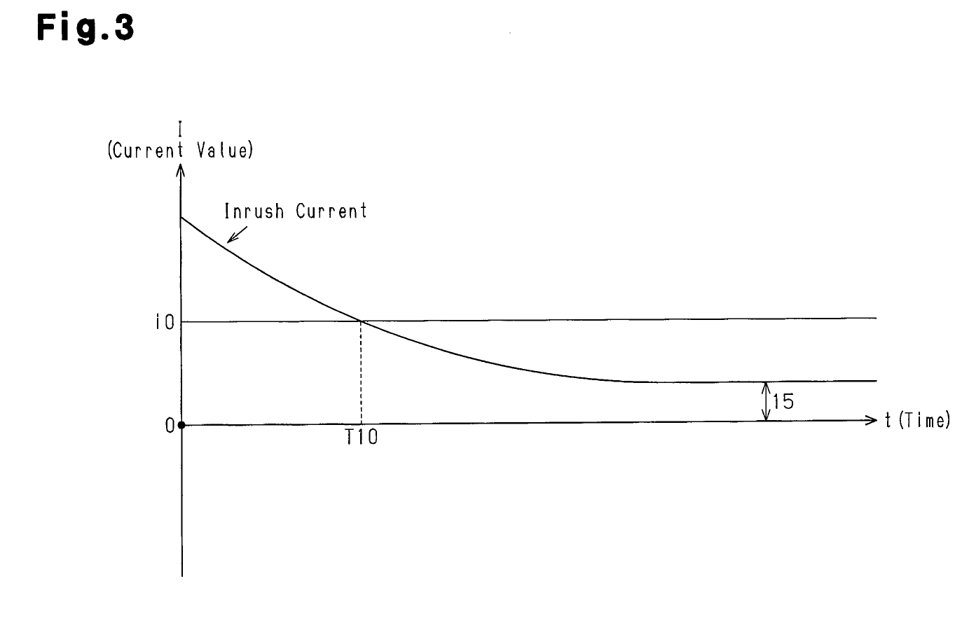

As described above, when starting operation of the motor 10, for example, when activating the third FET 3 and the second FET 2 to drive and produce forward rotation with the motor 10, as shown in FIG. 3, a large current exceeding the threshold value, or inrush current, momentarily flows to the motor 10. The current value of the inrush current gradually decreases and becomes less than the reference current value i0 after the inrush current time T10 elapses. As time further elapses, the current value enters the steady current range 15 and such steady state continues thereafter. Inrush current also flows to the motor 10 when driven to produce reverse rotation. Such inrush current may be erroneously detected as overcurrent. However, the overcurrent determination time T1 is set to be longer than the time (inrush current time T10) from when inrush current exceeding the threshold value is generated to when the inrush current value becomes less than the threshold value. Thus, the control circuit 30 does not erroneously detect the inrush current as overcurrent.

Dust or moisture may short-circuit an internal wire (not shown) of the motor 10 to a power supply line or a ground line. In this case, for example, when the motor 10 is producing forward rotation, current greatly exceeding the threshold value (reference current value i0), or overcurrent, may flow in the forward direction 21. The overcurrent heats the FETs. The heat raises the temperature and increases the value of the on resistance generated when the FETs are activated. As a result, the current stabilizes after stabilization time T2, which is shown in FIG. 2. Due to changes in the on resistance value of the FETs that have such characteristics, the value of the current i7 (overcurrent) detected from the voltages at the resistors R1 and R2 gradually decreases as shown in FIG. 2 and becomes constant after the stabilization time T2.

When current that is greater than or equal to reference current value i0 is continuously detected over the overcurrent determination time T1, the control circuit 30 determines that overcurrent is flowing. As described above, the overcurrent determination time T1 is set taking into consideration the amount the overcurrent varies due to changes in the on resistance of the FETs. Here, the overcurrent determination time T1 is set to be shorter than the time overcurrent decreases to the threshold value (reference current value i0) as the on resistance of the FET increases. Further, the overcurrent determination time T1 is set to be longer than the time from when the inrush current exceeding the threshold value is generated to when the inrush current decreases to a value that is less than the threshold value. This ensures that overcurrent is detected. When overcurrent is generated (for example, when forward rotation is being produced), the control circuit 30 performs an overcurrent protection operation to deactivate the third FET 3. As a result, overcurrent stops flowing to the motor 10, the first FET 1, the second FET 2, and the like. This prevents circuit elements such as the FETs and, consequently, the load driving device 5 from being damaged. When reverse rotation is being produced, in the same manner, the first FET 1 is deactivated to protect the load driving device 5 from overcurrent.

The load driving device 5 of the preferred embodiment has the advantages described below.

(1) If overcurrent is generated when forward rotation is being produced with the motor 10, the overcurrent flows from the third FET 3 via the motor 10 to the second FET 2. The overcurrent heats and raises the temperature of the second FET 2 and the third FET 3. This increases the resistance value of the second FET 2 and the third FET 3. As the resistance value increases, the value of the overcurrent decreases. The overcurrent determination value time T is set taking into consideration such variation of the overcurrent value. That is, the overcurrent determination time T1 is set to be shorter than the time for the overcurrent to decrease to the reference current value i0. This allows for detection of current continuously exceeding the threshold value (reference current value i0) over the overcurrent determination time T1 to be detected as overcurrent. As a result, overcurrent is detected without being affected by resistance value changes caused by the heating of FETs. This prevents the load driving device 5 including the FETs from being damaged by overcurrent. In the same manner, overcurrent is also correctly detected when reverse rotation is being produced by the motor 10 thereby preventing damaging of the load driving device 5.

(2) The third FET 3 and the second FET 2 are activated when producing forward rotation with the motor 10. In this state, a large current exceeding the threshold value, or inrush current, momentarily flows to the motor 10. The current value of the inrush current gradually decreases and becomes less than the reference current value i0 after the inrush current time T10 elapses. The overcurrent determination time T1 is set to be longer than the time from when inrush current is generated to when the inrush current value becomes less than the reference current value i0, which is the threshold value. This prevents the inrush current from being erroneously detected as overcurrent. In the same manner, erroneous overcurrent detection is prevented when reverse rotation is being produced by the motor 10.

It should be apparent to those skilled in the art that the present invention may be embodied in many other specific forms without departing from the spirit or scope of the invention. Particularly, it should be understood that the present invention may be embodied in the following forms.

The resistor R1 may be arranged closer to the power supply Vcc than the node between the FET 1 and the motor 10. In this case, the resistor R1 is used to detect current flowing through the current path in the reverse direction 22. In the same manner, the resistor R2 may be arranged closer to the power supply Vcc than the node between the FET 3 and the motor 10. In this case, the resistor R2 is used to detect current flowing through the current path in the forward direction 21.

The load is not limited to the motor 10 and may be, for example, an amplifier or a lamp. In this case, the semiconductor switches used to switch the current flowing to the load are changed in accordance with the type of load.

The semiconductor switch is not limited to a field-effect transistor (FET) and may be, for example, a bipolar transistor.

The drive circuit that drives the motor is not limited to an H-bridge circuit including four FETs. For example, to produce forward rotation or reverse rotation with a motor, a half-bridge circuit including two FETs or a thyristor may be used as a semiconductor switch. Further, when the load is a lamp or the like, a single FET or thyristor may be arranged in a current path extending from a power supply to the load.

In the preferred and illustrated embodiment, current is detected from the voltages of the resistors R1 and R2, which function as current detectors. Instead of a resistor, for example, a comparator may be used as the current detector. In this case, the comparator compares input current (the current flowing through a current path of a load driving device) with the reference current value i0 and outputs a signal indicating whether or not the input current is exceeding the reference current value i0 to the control circuit 30. Based on the signal output from the comparator, the control circuit 30 determines whether or not overcurrent is flowing and provides the gate terminal of an FET with a control signal (voltage).

The present examples and embodiments are to be considered as illustrative and not restrictive, and the invention is not to be limited to the details given herein, but may be modified within the scope and equivalence of the appended claims.

What is claimed is:

1. A load driving device comprising:
a semiconductor switch arranged in a current path extending from a power supply to a load;
a control circuit which controls activation and deactivation of the semiconductor switch, in which the control circuit deactivates the semiconductor switch when it is determined that overcurrent is flowing through the current path; and
a current detector which detects current flowing through the current path;
wherein the control circuit determines that overcurrent is flowing through the current path when the current detector continuously detects current that exceeds a threshold value over a predetermined detection time; and
the detection time is set to be shorter than the time from when the current flowing through the current path exceeds the threshold value to when an increase in resistance value of the semiconductor switch resulting from heat generated by the current lowers the current to the threshold value.

2. The load driving device according to claim 1, wherein the detection time is determined based on an amount that overcurrent varies when the semiconductor switch is heated.

3. The load driving device according to claim 1, wherein the threshold value is set at a current level at which occurrence of overcurrent is determinable by the control circuit when the semiconductor switch is heated due to the overcurrent.

4. The load driving device according to claim 1, wherein:
the load momentarily generates inrush current that exceeds the threshold value when starting operation by receiving power from the semiconductor switch; and
the detection time is set to be longer than the time from when the inrush current is generated to when the inrush current is lowered to less than the threshold value.

5. The load driving device according to claim 1, wherein:
the semiconductor switch includes first and second field-effect transistors, which form a first series circuit, and third and fourth field-effect transistors, which form a second series circuit, with the first and second series circuit being connected in parallel to form an H-bridge circuit, and the load being connected to a node between the first and second field-effect transistors and a node between the third and fourth transistors; and
the current detector includes:
a first detector arranged between the first and second field-effect transistors; and
a second detector arranged between the third and fourth field-effect transistors.
